(19) United States
(12) Patent Application Publication
(10) Pub. No.: US 2014/0347725 A1
(43) Pub. Date: Nov. 27, 2014

(54) IMAGE DISPLAY DEVICE AND OPTICAL DEVICE

(71) Applicant: FUJITSU LIMITED, Kawasaki-shi (JP)

(72) Inventor: Toshiro OHBITSU, Akishima (JP)

(21) Appl. No.: 14/459,381

(22) Filed: Aug. 14, 2014

Related U.S. Application Data
(63) Continuation of application No. PCT/JP2012/055749, filed on Mar. 7, 2012.

(51) Int. Cl. G02B 27/22

(52) U.S. Cl. CPC G02B 27/2214
USPC 359/463

(57) ABSTRACT

Provided is an image display device including: a display unit where the display elements are arranged in a matrix shape; a lens unit which is configured by arranging a plurality of lenses along an inclined row display element group including a plurality of display elements which are consecutively disposed in a direction inclined with respect to the array direction in the display unit, the lenses corresponding to the inclined row display element group, the lenses focusing output light of the display elements constituting the inclined row display element group; and light-shielding portions which prevent output light of unnecessary component output elements which are the display elements other than the display elements constituting the inclined row display element group corresponding to the lenses from being emitted from the lenses, so that it is possible to suppress the occurrence of crosstalk.

### CROSS-REFERENCE TO RELATED APPLICATION

This application is a continuation application of International Application PCT/JP2012/055749, filed on Mar. 7, 2012 and designated the U.S., the entire contents of which are incorporated herein by reference.

### FIELD

The embodiments discussed herein are related to an image display device and an optical device.

### BACKGROUND

There is a stereoscopic image generation device which generates a stereoscopic image by using a parallax of images photographed by two adjacent cameras. For example, among the images photographed by the two adjacent cameras, the stereoscopic image generation device generates the image photographed by one camera as a left-eye image and the image photographed by the other camera as a right-eye image and displays the images.

With respect to the same object, a difference between the position in the left-eye image and the position in the right-eye image is called a parallax. With respect to two objects existing in an image, the parallax amounts thereof are different, so that one object seems to exist in the front or back relative to the other object. The parallax amount is the magnitude of parallax.

In addition, there is a stereoscopic image generation device where lenticular-shaped lenses (lenticular lenses) are installed in a display unit such as a liquid crystal display, so that different images are perceived by right and left eyes without using dedicated glasses. More specifically, a lens sheet configured by consecutively arranging lenticular lenses is arranged between the display unit and a viewer.

In other words, the left-eye image and the right-eye image are alternately displayed on the display unit and these images are viewed through the lenticular lenses, and thus, the left eye can view only the left-eye image and the right eye can view only the right-eye image, so that the images can be perceived as an stereoscopic image.

In addition, there is also known an inclined lenticular lens type where deterioration in resolution is distributed over the vertical and horizontal directions of a to-be-displayed image, so that a high image quality can be obtained.

FIG. 11 is a diagram illustrating a relation between a pixel array and lenticular lenses of a display unit in a stereoscopic image generation device in the related art. In addition, for the convenience of description, FIG. 11 illustrates only one lenticular lens 511 among a plurality of the lenticular lenses 511 constituting a lens sheet. In addition, in FIG. 11, the lenticular lens 511 is indicated by a broken line.

In the example illustrated in FIG. 11, the lenticular lens 511 is arranged to be inclined with respect to the array direction of display elements on a display surface 510a of the display unit. On the display surface 510a, the display elements of color pixels are arranged in the horizontal direction (array direction) with respect to the display surface 510a and the vertical direction perpendicular to the horizontal direction. In the example illustrated in FIG. 11, the lenticular lens 511 is arranged in the inclined direction (non-parallel direction) inclined with respect to the vertical direction of the array of the display elements on the display surface 510a.

Accordingly, each pixel displayed on the display surface 510a is displayed by using the display elements aligned in the inclined direction. In the example illustrated in FIG. 11, for the convenience of description, the display elements constituting one pixel are denoted by the same alphabet as an identification symbol.

For example, in the example illustrated in FIG. 11, the display elements B12, G22, and R32 constitute one pixel (pixel D). In addition, other display elements also have the same configuration. The alignment direction of the display element of each pixel is parallel to the direction of each lenticular lens 511. In the example illustrated in FIG. 11, one pixel is arranged in the inclined direction.

Herein, most of light beams output from the three display elements displaying the pixel D are incident on the same lenticular lens 511 and are focused on predetermined positions either of the right eye or left eye of the viewer by the lens. The other pixels also have the same configuration. In addition, the pixels for the left-eye image and the pixels for the right-eye image are alternately arranged.

As illustrated in FIG. 11, the lenticular lens 511 is arranged to be inclined with respect to the array of the display elements and one pixel is arranged in the inclined direction, so that deterioration in resolution uniformly occurs in the vertical and horizontal directions. In other words, the deterioration in resolution can be prevented from occurring in only one of the vertical and horizontal directions. In a case where the deterioration in resolution occurs in both of the vertical and horizontal directions, the viewer recognizes the deterioration in image quality to be low in comparison with a case where the deterioration in resolution occurs only in one of the vertical and horizontal directions.
Patent Literature 1: Japanese Laid-open Patent Publication No. 2005-176004
Patent Literature 2: Japanese Laid-open Patent Publication No. 06-301033
Patent Literature 3: Japanese Laid-open Patent Publication No. 04-035192

However, for example, in the stereoscopic image generation device illustrated in FIG. 11, light beams output from color pixels constituting pixels other than the pixel D, for example, color pixels G12, B22, R22, G32, and the like also enter the lenticular lens 511, so that crosstalk occurs.

### SUMMARY

According to an aspect of the embodiments, there is provided an image display device including: a display unit where the display elements are arranged in a matrix shape by arranging the display elements in an array direction and a direction perpendicular to the array direction; a lens unit which is configured by arranging a plurality of lenses along an inclined row display element group including a plurality of display elements which are consecutively disposed in a direction inclined with respect to the array direction in the display unit, the lenses corresponding to the inclined row display element group, the lenses focusing output light of the display elements constituting the inclined row display element group; and light-shielding portions which prevent output light of unnecessary component output elements which are the display elements other than the display elements constituting the inclined row display element group corresponding to the lenses from being emitted from the lenses.

According to another aspect of the embodiments, there is provided an optical device attached to a display unit where the display elements are arranged in a matrix shape by arranging the display elements in an array direction and a direction perpendicular to the array direction, the optical device including: a lens unit which is configured by arranging a plurality of lenses along an inclined row display element group including a plurality of display elements which are consecutively disposed in a direction inclined with respect to the array direction in the display unit, the lenses corresponding to the inclined row display element group, the lenses focusing output light of the display elements constituting the inclined row display element group; and light-shielding portions which prevent output light of unnecessary component output elements which are the display elements other than the display elements constituting the inclined row display element group corresponding to the lenses from being emitted from the lenses.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating a configuration of a stereoscopic image display device as an example of a first embodiment.

FIG. 2 is a diagram illustrating an example of an array of display elements of a display unit in the stereoscopic image display device as the example of the first embodiment.

FIG. 3 is a schematic diagram illustrating a configuration of a liquid crystal display of the stereoscopic image display device as the example of the first embodiment.

FIG. 4 is a schematic diagram illustrating a hardware configuration of a display control unit of the stereoscopic image display device as the example of the first embodiment.

FIG. 5 is a diagram illustrating an example of installation of a lens sheet with respect to the display unit.

FIG. 6 is a schematic cross-sectional view illustrating a positional relation among the liquid crystal display, flat-convex lenses, and light-shielding portions in the stereoscopic image display device as the example of the first embodiment.

FIG. 7 is a diagram for describing a shape of the light-shielding portion of the lens sheet in the stereoscopic image display device as the example of the first embodiment.

FIG. 8 is a diagram for describing a shape of the light-shielding portion of the lens sheet in the stereoscopic image display device as the example of the first embodiment.

FIG. 9 is a flowchart for describing processes of the display control unit in the stereoscopic image display device as the example of the first embodiment.

FIG. 10 is a schematic diagram illustrating a configuration of a stereoscopic image display device as an example of a second embodiment.

FIG. 11 is a diagram illustrating a relation between a pixel array and lenticular lenses of a display unit in a stereoscopic image generation device of the related art.

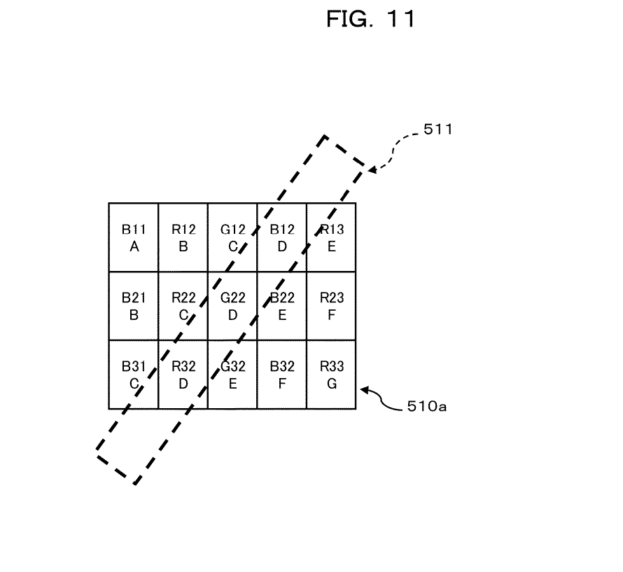

### DESCRIPTION OF EMBODIMENT(S)

Hereinafter, embodiments of a stereoscopic image display device and an optical device will be described with reference to the drawings. However, the embodiments described hereinafter are the only exemplary ones, and there is no intension of excluding applications of various modifications and techniques which are not explicitly disclosed in the embodiments. In other words, various modifications (combinations of the embodiments and modified examples) of the embodiments can be implemented within the scope without departing from the spirit of the present invention. In addition, each figure does not intend to include only the components illustrated in the figure, but it may include other functions and the like.

### (A) First Embodiment

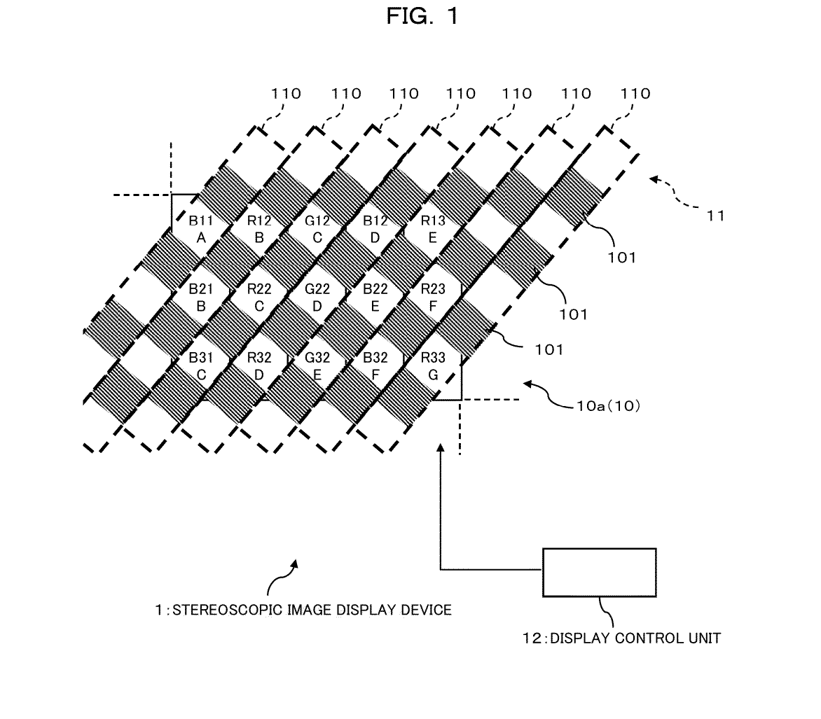

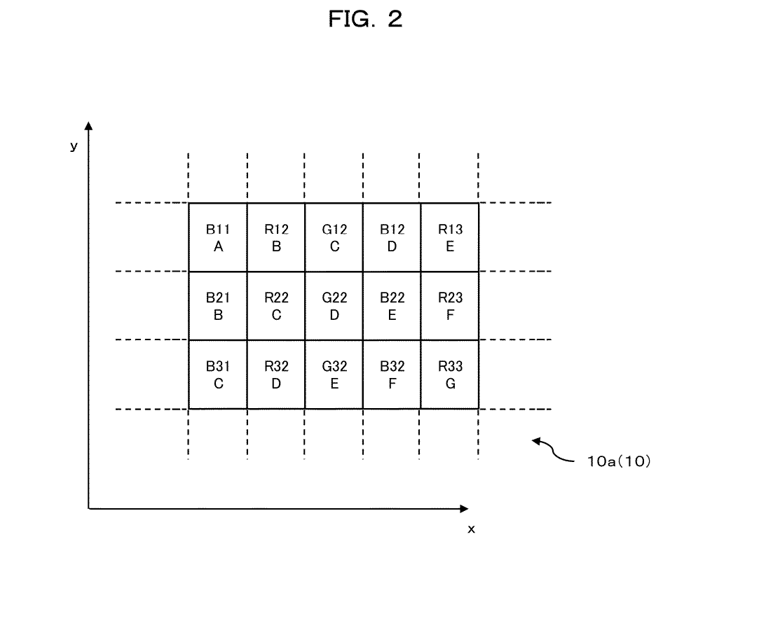

FIG. 1 is a schematic diagram illustrating a configuration of a stereoscopic image display device 1 as an example of a first embodiment, and FIG. 2 is a diagram illustrating an example of an array of display elements of a display unit 10 of the stereoscopic image display device 1.

In the stereoscopic image display device (image display device) 1, a viewer is positioned so as to face the display unit 10 of which display surface 10a is attached with a lens sheet 11, and images (stereoscopic images) for stereoscopic display of a display object are displayed on the display surface 10a, so that the viewer stereoscopically views the display object.

The images for stereoscopic display are, for example, images photographed by two adjacent cameras. An image photographed by one of the two cameras is used as a left-eye image, and an image photographed by the other is used as a right-eye image. Stereoscopically viewing can be achieved by the two images having a parallax. In addition, the images for stereoscopic display can be created by various existing methods, and the detailed description is not provided. In addition, the images for stereoscopic display (3D image) displayed by the stereoscopic image display device 1 may be moving pictures or still images.

As illustrated in FIG. 1, the stereoscopic image display device 1 as the example of the first embodiment is configured to include the display unit 10, the lens sheet (optical device) 11, and a display control unit 12.

The display unit 10 is, for example, a liquid crystal display and displays images on the display surface 10a under the control of the display control unit 12. In other words, in the stereoscopic image display device 1, the images for stereoscopic display are displayed on the display unit 10. In addition, the images for stereoscopic display include the left-eye image and the right-eye image. Hereinafter, an example of the display unit 10 when the display unit 10 is the liquid crystal display is provided, and in some cases, the display unit 10 may be indicated as a liquid crystal display 10.

The display surface 10a of the liquid crystal display 10 is formed as a flat surface, and elements (display elements) of a plurality of color pixels are arranged on the display surface 10a in the horizontal direction (horizontal direction in FIG. 1 or FIG. 2; the array direction) of the display surface 10a and the vertical direction (vertical direction in FIG. 1 or FIG. 2) perpendicular to the horizontal direction. In other words, on the display surface 10a of the liquid crystal display 10, the display elements are arranged in the array direction and the direction perpendicular to the array direction, so that the display elements are arranged in a matrix shape.

A plurality of the pixels constituting an image (stereoscopic image) displayed on the display surface 10a is represented by the respective display elements.

More specifically, each pixel includes a plurality of the color pixels. As an example of the color pixels, there are, for example, color pixels representing the primary colors of light, that is, red (R), green (G), and blue (B). As illustrated in FIG. 2, the display elements of the color pixels are repetitively arranged on the display surface 10a in the array direction in a predetermined order. In addition, the display elements of the same type are consecutively arranged in the direction perpendicular to the array direction. A black matrix may be arranged in the boundary portion of each display element. In addition, on the display surface 10a, one pixel is represented by the display elements of the three consecutive color pixels R, G, and B.

In addition, in the first embodiment, the display element of each color pixel is a rectangular display element of which light-emitting portion has a rectangular shape.

In the stereoscopic image display device 1, as illustrated in FIG. 2, with respect to the vertical direction of the array of the display elements on the display surface 10a, one pixel is represented by the display elements of the three (consecutive) color pixels R, G, and B which are aligned in the inclined direction (non-horizontal direction). Namely, one pixel is arranged in the inclined direction. In the example illustrated in FIG. 1 or FIG. 2, for the convenience of description, the display elements of the color pixels constituting the same pixel are designated with the same alphabet as an identification symbol.

For example, in the example illustrated in FIG. 2, the display elements B12, G22, and R32 of the color pixels constitute one pixel (pixel D). In addition, the display elements of other color pixels have the same configuration.

In FIG. 2, in a case where the horizontal direction (array direction) is set as the x direction and the vertical direction is set as the y direction, for example, when the position of the display element G22 is represented by a coordinate (m, n), the position of the display element B12 is represented by a coordinate (m+1, n+1). Similarly, the position of the display element R32 is represented by a coordinate (m−1, n−1).

In the stereoscopic image display device 1, the three display elements positioned in the inclined direction of the coordinates (m−1, n−1), (m, n), and (m+1, n+1) constitute one pixel. Hereinafter, in the liquid crystal display 10, the three display elements positioned in the inclined direction constituting one pixel are referred to as an inclined row display element group.

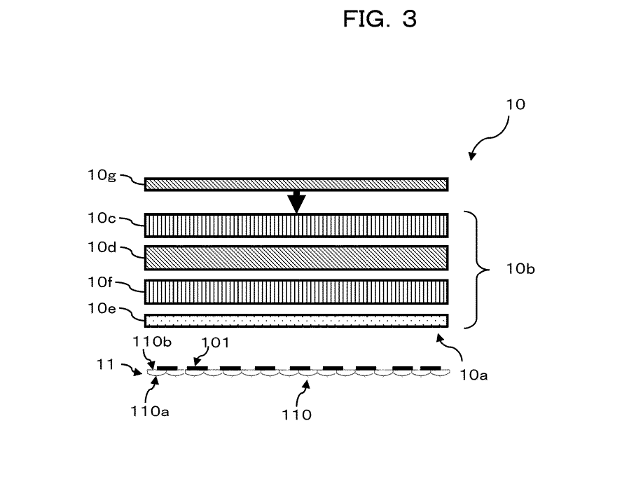

FIG. 3 is a schematic diagram illustrating a configuration of the liquid crystal display 10 of the stereoscopic image display device 1 as the example of the first embodiment.

For example, as illustrated in FIG. 3, the liquid crystal display 10 is configured to include a backlight 10g and a liquid crystal panel 10b. In addition, FIG. 3 illustrates the liquid crystal display 10 having a general transmission-type liquid crystal panel as an example of the liquid crystal display 10.

The backlight 10g is a light source and irradiates the liquid crystal panel 10b with light.

The liquid crystal panel 10b performs display by using the display elements by partially shielding or transmitting the light irradiated from the backlight 10g. The liquid crystal panel 10b is configured to include a diffusion plate 10c, polarizing plates 10d and 10e, and a liquid crystal cell 10f.

The diffusion plate 10c diffuses the light irradiated from the backlight 10g to allow the light to uniformly impinge on the polarizing plates 10d and 10e or the liquid crystal cell 10f.

The polarizing plates 10d and 10e are polarizing filters which transmit only the light (polarization light) having an amplitude component in a specific direction among the light beams irradiated from the backlight 10g. The polarizing plates 10d and 10e transmit the light having amplitude components in different directions (for example, perpendicular directions).

The liquid crystal cell 10f is arranged between the polarizing plate 10d and the polarizing plate 10e. The liquid crystal cell 10f is configured to electrodes, an alignment film, spacers, color filters, and the like, and a cell sealing a liquid crystal material is formed in a region configured with the alignment film or the spacers. Accordingly, the display elements of the color pixels R, G, and B are formed.

On the liquid crystal panel 10b, the later-described lens sheet 11 is arranged so that a flat surface 110b side thereof faces the polarizing plate 10e. In addition, the later-described light-shielding portions 101 are partially formed in the flat surfaces 110b of the lens sheet 11.

The light irradiated from the backlight 10g passes through the diffusion plate 10c, the polarizing plate 10d, the liquid crystal cell 10f, and the polarizing plate 10e in this order and enters the lens sheet 11. At this time, in the portions of the lens sheet 11 where the light-shielding portions 101 are arranged, the light-shielding portions 101 prevent the light irradiated from the liquid crystal panel 10b from entering. In other words, the light irradiated from the backlight 10g enters the portion of the lens sheet 11 where the light-shielding portions 101 are not formed, and the entering light passes through the flat-convex lenses 110.

Next, the light passing through the flat-convex lenses 110 is emitted from convex lenses 110a and focused on the viewer's eyes.

In the first embodiment, the liquid crystal display 10 has, for example, a size of 23-inch monitor and a resolution of about 1600×900 (dots). In a general liquid crystal display 10, the size of each of the display elements R, G, and B is about 0.418 mm in the horizontal direction (the horizontal direction in FIG. 2) and about 0.705 mm in the vertical direction (the vertical direction in FIG. 2.

In addition the resolution or size of the liquid crystal display 10 and the size of the display element are not limited to the above ones, but appropriate modifications are available. In addition, although FIG. 3 illustrates the liquid crystal display 10 having a transmission-type liquid crystal display, the liquid crystal displays 10 using various other methods can be used as the liquid crystal display 10.

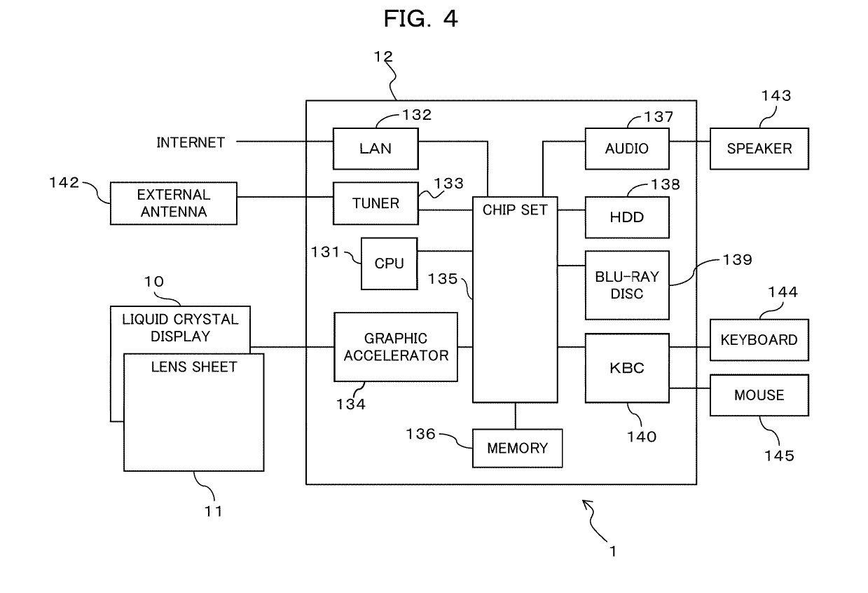

FIG. 4 is a schematic diagram illustrating a hardware configuration of the display control unit 12 of the stereoscopic image display device 1 as the example of the first embodiment.

As illustrated in FIG. 4, the display control unit 12 is configured as an information processing unit (computer) which includes, for example, a CPU (Central Processing Unit) 131, a LAN (Local Area Network) card 132, a tuner 133, a graphic accelerator 134, a chip set 135, a memory 136, an audio controller 137, an HDD (Hard Disk Drive) 138, a Blu-ray disc drive 139, and a keyboard controller 140.

The graphic accelerator 134 is an image display control interface which is connected to the liquid crystal display 10 and allows the liquid crystal display 10 to perform image display. In addition, the chip set 135 may be configured to have the function as the graphic accelerator 134. The LAN card 132 is an interface card for access to a network such as the Internet, and the tuner 133 is connected to an external antenna 142 to receive a TV program, to perform a decoding process or the like, and to display image data on the display unit 10.

The memory 136 is, for example, a storage device such as a RAM (Random Access Memory) or a ROM (Read Only Memory) and stores various programs or data which are executed or used by the CPU 131.

The audio controller 137 is connected to a speaker 143 and controls output of audio data of the speaker 143.

The HDD 138 is a storage device and stores an OS (Operating System), various programs, data, and the like which are executed or used by the CPU 131. In addition, various image data (image data and stereoscopic image data) which are displayed on the display unit 10 are also stored in the HDD 138 or the memory 136.

In addition, stereoscopic image data which are produced in advance with respect to a stereoscopic display object (display object) are stored in the HDD 138. In other words, the HDD 138 functions as a storage unit which stores images for stereoscopic display of every parallax point with respect to the display object corresponding to every viewing point.

The Blu-ray disc drive 139 reproduces a Blu-ray disc. In addition, various image data (image data and stereoscopic image data) which are displayed on the liquid crystal display 10 may be stored in the Blu-ray disc. In addition, a reproduction device which can reproduce a recording medium (for example, a DVD or the like) besides the Blu-ray disc may be provided, so that various image data stored in the recording medium may be reproduced.

The keyboard controller 140 is connected to an input unit such as a keyboard 144 or a mouse 145 to control data exchange between the keyboard 144 or the mouse 145 and the CPU 131. The chip set 135 is connected to these components via a bus or the like to control communication between the CPU 131 and these components.

The CPU 131 is a processing unit which implements various functions by executing programs stored in the HDD 138 or the memory 136.

The CPU 131 displays contents such as moving images or still images on the display surface 10a of the liquid crystal display 10 by executing, for example, an image reproduction application, so that the CPU 131 implements an image display function as the display control unit 12.

For example, the display control unit 12 displays a right-eye image on a specific inclined row display element group used for displaying the right-eye image among a plurality of inclined row display element groups (display elements) constituting the display surface of the liquid crystal display 10. Similarly, the display control unit 12 displays a left-eye image on a specific inclined row display element group used for displaying the left-eye image among a plurality of the inclined row display element groups (display elements) constituting the display surface of the liquid crystal display 10. The display control unit 12 displays the stereoscopic image on the liquid crystal display 10 by performing the above-described control.

The display control unit 12 displays the stereoscopic image on the liquid crystal display 10 by controlling luminance values or the like of the three display elements constituting the inclined row display element group in the display surface 10a of the liquid crystal display 10 corresponding to one pixel of the to-be-displayed stereoscopic image. More specifically, for example, the display control unit 12 allows the light source of the backlight 10g to generate pixel light by controlling the backlight 10g or the liquid crystal panel 10b.

In addition, the display control unit 12 may display the image on the liquid crystal display 10 by controlling luminance values or the like of the three display elements R, G, and B aligned in the array direction in the display surface 10a of the liquid crystal display 10 corresponding to one pixel of the to-be-displayed image.

The image which is to be displayed on the liquid crystal display 10 may be recorded in, for example, the HDD 138, the memory 136, the Blu-ray disc, or the like and may be received through the LAN card 132 or the tuner 133, and various modifications are available.

In addition, the program (an image reproduction application) for implementing various functions such as the image display function is provided in the form where the program is recorded in, for example, a computer-readable recording medium such a flexible disc, a CD (CD-ROM, a CD-R, a CD-RW, or the like), a DVD (a DVD-ROM, a DVD-RAM, a DVD-R, a DVD+R, a DVD-RW, a DVD+RW, or the like), a Blu-ray disc, a magnetic disc, an optical disc, or an optical magnetic disc. In addition, the computer reads out the program from the recording medium, and transmits and stores the program in an internal storage device or an external storage device in order to use the program. In addition, the program is recorded in, for example, a storage device (recording medium) such as a magnetic disc, an optical disc, an optical magnetic disc, and the program may be provided from the storage device to the computer through a communication line.

In order to implement various functions such as the image display function, the program stored in an internal storage device (the memory 136 in the embodiment) is executed by a microprocessor (the CPU 131 in the embodiment) of the computer. In this case, the program recorded in the recording medium may be read out and executed by the computer.

In addition, in the embodiment, the computer is a concept including hardware and an operating system and denotes hardware operated under the control of the operating system. In addition in a case where an operating system is not needed and an application program independently operates hardware, the hardware itself corresponds to a computer. The hardware is configured to include at least a microprocessor such as a CPU and a unit for reading out a computer program recorded in a recording medium, and in the embodiment, the stereoscopic image display device 1 has a function as a computer.

The functions as the display control unit 12 can be implemented by various existing methods, and the detailed description will not be provided.

The lens sheet (lens unit) 11 is configured with a lens array where a plurality of flat-convex lenses 110 which are lenticular lenses and have semi-circular shapes are arranged so that generating lines of the flat-convex lenses 110 are consecutively aligned in parallel.

As illustrated in FIG. 3, the lens sheet 11 is arranged so that, at the side of the display surface 10a of the liquid crystal display 10, the flat surface 110b at the side opposite to the convex lenses 110a protruding in the flat-convex lenses 110 faces the display surface 10a of the display unit 10.

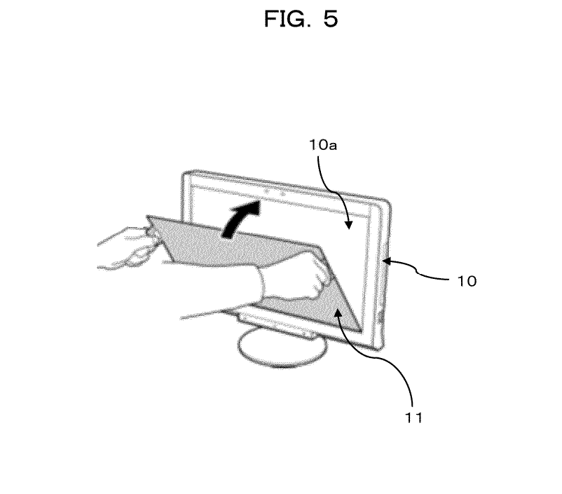

FIG. 5 is a diagram illustrating an example of installation of the lens sheet 11 with respect to the display unit 10. As illustrated in FIG. 5, the lens sheet 11 is fixed and attached at a predetermined position in front of (at the viewer side of) the display surface 10a of the display unit 10. The installation of the lens sheet 11 in the liquid crystal display 10 is performed, for example, by fixing to a hook (not shown) or the like. In this manner, the lens sheet 11 is configured so as to be detachable from the display surface 10a of the liquid crystal display 10, so that the liquid crystal display 10 can also be used as a general two-dimensional image display unit in the state where the lens sheet 11 is detached from the liquid crystal display 10. In addition, the lens sheet 11 may be adhered to the display surface 10a of the liquid crystal display 10.

In addition, in the lens sheet 11, optical axes of the convex lenses 110a of the flat-convex lenses 110 are arranged to be parallel to each other, and thus, the flat-convex lenses 110 are formed to be directed in the same direction.

The flat-convex lenses 110 are formed by using the same material and are formed to have the same shape such as curvatures of the convex lenses 110a or distances from the apexes of the convex lenses 110a to the flat surface 110b, so that f values thereof are the same.

In addition, as illustrated in FIG. 1, the lens sheet 11 is arranged so that the flat-convex lenses 110 are parallel to the inclined row display element group constituting one pixel in the above-described liquid crystal display 10 and overlap the inclined row display element group. In other words, the lens sheet 11 is arranged so that the generating lines of the flat-convex lenses 110 are inclined with respect to the parallel direction of the display elements on the display surface 10a.

More specifically, the flat-convex lenses 110 constituting the lens sheet 11 are arranged along the three display elements (the inclined row display element group) positioned at the coordinates (m−1, n−1), (m, n), and (m+1, n+1) in the inclined direction in the liquid crystal display 10 to overlap the three display elements. In other words, the flat-convex lenses 110 are arranged to be inclined with respect to the parallel direction of the display elements on the display surface 10a of the liquid crystal display 10.

Accordingly, at the side of the display surface 10a, the light beams irradiated from the three display elements constituting the inclined row display element group are incident on the flat surface 110b (rear surface) of the same flat-convex lens 110.

In other words, the light beams output from the three display elements constituting one inclined row display element group are incident on the same flat-convex lens 110. In addition, each inclined row display element group on the display surface 10a of the liquid crystal display 10 corresponds to one flat-convex lens 110. Hereinafter, a combination of the inclined row display element group and the flat-convex lens 110 corresponding to the inclined row display element group are referred to as an output pair. The light beams output from the inclined row display element group, which forms the output pair, are incident on the flat-convex lens 110.

The light beams (three primary colors) output from the inclined row display element group (for example, R32, G22, and B12) constituting one pixel pass through the flat-convex lens 110, and after that, are emitted from the convex lens 110a. Next, the light beams are focused to intersect each other at positions separated by a predetermined distance from the display surface 10a of the liquid crystal display 10. More specifically, the light beam passing through the flat-convex lens 110 is focused on only one of the right and left eyes of the viewer.

In this manner, the flat-convex lenses 110 are arranged corresponding to the inclined row display element group and along the inclined row display element group on the display surface 10a of the liquid crystal display 10 to focus the output light beams from the display elements constituting the inclined row display element group.

In addition, the focused position of the output light is determined, for example, according to the focal length of the flat-convex lens 110, the distance between the display surface 10a of the liquid crystal display 10 and the flat-convex lens 110, and the like. Therefore, the focal length and the like are set to optimal values in advance based on the position, posture, and the like of the viewer so that the output light beams are focused on the positions of the eyes of the viewer. The method of setting the focal length and the like is implemented by using various existing methods, and the detailed description is not provided.

As described above, in the stereoscopic image display device 1, since one flat-convex lenses 110 corresponds to one pixel, the light beams of one pixel can be focused at an accurate focal length without a decrease in light intensity (light amount).

In addition, in the lens sheet 11, each flat-convex lens 110 includes light-shielding portions 101 which prevent the output light (unnecessary pixel component) of other display elements which are different from the display elements constituting the inclined row display element group, which forms the output pair together with the flat-convex lens 110, from being output from the flat-convex lens 110.

The light-shielding portions 101 prevent the output light (unnecessary pixel component) of other display elements which are different from the display elements constituting the inclined row display element group, which forms the output pair together with the flat-convex lens 110, from being incident on the flat-convex lens 110, so that the unnecessary pixel component is prevented from being output from the flat-convex lens 110.

Hereinafter, in some cases, other display elements which output the unnecessary pixel component and are different from the display elements constituting the inclined row display element group, which forms the output pair together with the flat-convex lens 110, are referred to as unnecessary component output elements.

The light-shielding portions 101 shield the unnecessary pixel components output from the unnecessary component output elements at the side of the flat surface 110b, so that the unnecessary pixel component is prevented from being incident on the flat-convex lens 110.

The unnecessary component output elements are the display elements which are adjacent to the inclined row display element group, which forms the output pair together with the flat-convex lens 110, in the vertical or horizontal direction and which face (overlap) the flat surface 110b of the flat-convex lens 110. Hereinafter, the regions of the unnecessary component output elements which overlap the flat-convex lens 110 are referred to as light-shielding target regions.

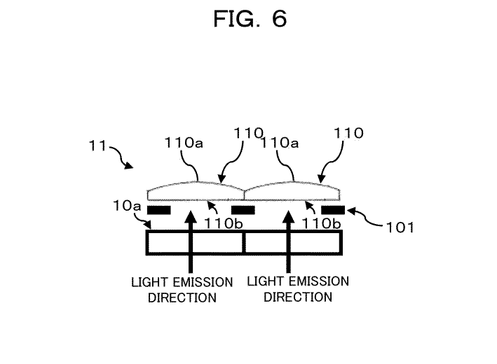

FIG. 6 is a schematic cross-sectional view illustrating a positional relation among the liquid crystal display 10, the flat-convex lenses 110, and the light-shielding portions 101 in the stereoscopic image display device 1 as the example of the first embodiment. As illustrated in FIG. 6, the light-shielding portions 101 are arranged between the flat surface 110b of the flat-convex lenses 110 and the display surface 10a of the liquid crystal display 10. In addition, in the example illustrated in FIG. 6, for the convenience of description, although the flat-convex lenses 110 and the light-shielding portions 101 are arranged to be separated from each other at intervals, it is preferable that the flat-convex lenses 110 and the light-shielding portions 101 be hermetically attached to each other.

The light-shielding portions 101 prevent the light (unnecessary pixel components) output from the unnecessary component output elements from being incident on the flat surface 110b of the flat-convex lenses 110.

The light-shielding portion 101 is, for example, a light-shielding film (black polyethylene light-shielding film) configured with a material having a high light shielding property such as black polyethylene in a film shape and is adhered to the flat surface 110b of the flat-convex lens 110.

However, the configuration of the light-shielding portions 101 is not limited thereto, but various modifications are available. For example, a material other than black polyethylene may be used as the light-shielding portion 101, and the light-shielding portions 101 may also be implemented by coating the flat surface 110b of the flat-convex lens 110 with a material having a high light shielding property instead of attaching the light-shielding film to the flat-convex lens 110. Furthermore, instead of being arranged at the side of the flat surface 110b of the flat-convex lenses 110, the light-shielding portions 101 may be arranged at the side of the convex lenses 110a, so that the unnecessary pixel components can be prevented from being output from the flat-convex lenses 110.

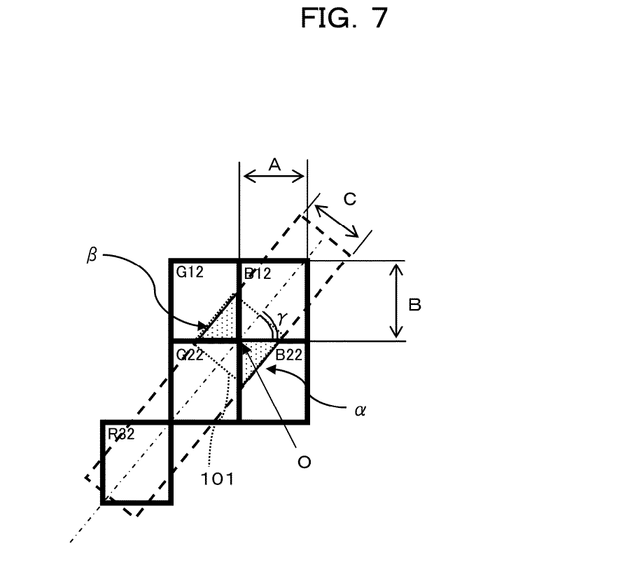

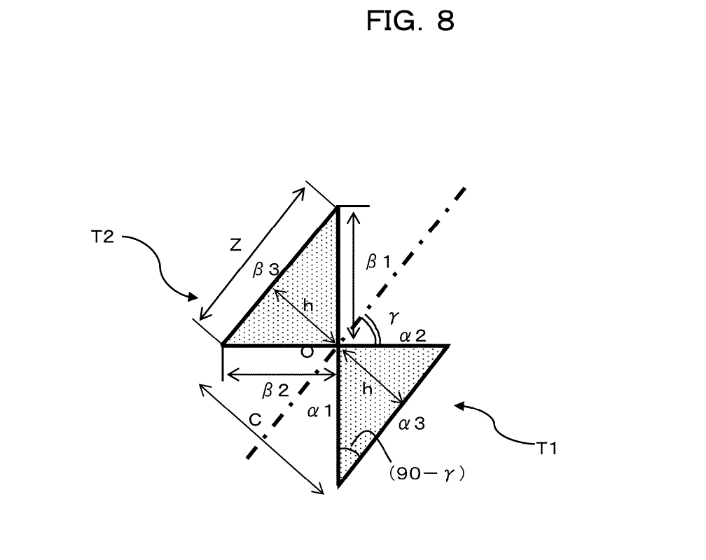

FIGS. 7 and 8 are diagrams for describing the shape of the light-shielding portion 101 of the lens sheet 11 in the stereoscopic image display device 1 as the example of the first embodiment. FIG. 7 is a diagram illustrating a positional relation between the flat-convex lenses 110 and the unnecessary component output elements, and FIG. 8 is a diagram illustrating the light-shielding target region illustrated in FIG. 7. In addition, for the convenience of description, only one light-shielding portion 101 is illustrated in FIG. 7, and the light-shielding portion 101 is not provided in illustration of FIG. 8.

The light-shielding portions 101 are formed at the positions where the light-shielding portions 101 cover the regions (light-shielding target regions) for the flat-convex lenses 110 where the flat surface 110b of the flat-convex lenses 110 face (overlap) the unnecessary component output elements in the state where the lens sheet 11 is attached to the liquid crystal display 10.

Hereinafter, the light-shielding target regions will be described with reference to FIGS. 7 and 8.

As illustrated in FIG. 7, the horizontal length of the display elements having a rectangular shape is denoted by A, and the vertical length thereof is denoted by B. In addition, the width of the flat-convex lens 110 is denoted by C. The display elements have the same dimension and shape on the entire display surface 10a of the liquid crystal display 10.

In the example illustrated in FIG. 7, the flat-convex lens 110 is arranged so that the generating line (refer to a one-dot dashed line in FIG. 7) is coincident with the diagonal line of the display elements R32, G22, and B12 constituting one inclined row display element group.

In addition, in the example illustrated in FIG. 7, in the flat-convex lens 110, which forms the output pair together with (corresponds to) the inclined row display element group (R32, G22, and B12) constituting one pixel, the light beams output from the display elements G12 and B22 are the unnecessary pixel components.

The regions of the display elements G12 and B22 which output the unnecessary pixel components, namely, the regions of the display elements G12 and B22 which face the flat-convex lens 110 corresponding to the inclined row display element group (R32, G22, and B12) are the light-shielding target regions. In FIG. 7, the light-shielding target region for the display element G12 is indicated by a reference numeral T1, and the light-shielding target region for the display element B22 is indicated by a reference numeral T2.

The three sides of the triangle T2 are denoted by β1, β2, and β3. In the triangle T2, the vertex O having a right angle faces the side β3. Similarly, the three sides of the triangle T1 are denoted by α1, α2, and α3. In the triangle T1, the vertex O having a right angle faces the side α3.

The light-shielding target regions T1 and T2 are right-angled triangles which are similar (or identical) to each other. Therefore, “the length of the side β1=the length of the side α1”, “the length of the side β2=the length of the side α2”, and “the length of the side β3=the length of the side α3”.

Herein, as illustrated in FIG. 7, the angle between one diagonal line of display element (for example, B12) and the side of the display element in the horizontal direction is denoted by γ. If the generating line of the flat-convex lens 110 is aligned with the diagonal line, the angle between the generating line and the side of the display element in the horizontal direction becomes γ.

As illustrated in FIG. 8, in the triangles T1 and T2 as the light-shielding target regions, the angle between the side in the vertical direction and the diagonal line is (90−γ). Therefore, the following relation is satisfied.

tan(90−γ)=A/B and tan γ=B/A

In addition, a sum of the height h from the side α3 to the vertex O of the triangle T1 and the height h from the side β3 to the vertex O of the triangle T2 is C. Therefore, the following Equation (1) is satisfied.

$$length ( Z ) of side β3 = [ C / 2 ] / tan ( 90 - γ ) + [ C / 2 ] / tan ( γ ) = C \times [ A \times A + B \times B ] / AB \qquad ( Equation 1 )$$

In the first embodiment, each light-shielding portions 101 has the same dimension as “the length (Z) of the side β3” obtained by at least the above-described Equation (1) along the generating line of the flat-convex lens 110 and is formed over the entire width C of the flat-convex lens 110 in the direction (the lens width direction) perpendicular to the generating line. In other words, the light-shielding portion 101 is formed as a rectangular shape having the same dimension as “the length (Z) of the side β3” in the direction of the generating line of the flat-convex lens 110 and the same dimension as the lens width C in the lens width direction.

In addition, in each flat-convex lens 110, a plurality of the light-shielding portions 101 is repetitively formed at the equal interval along the generating line, and the interval between the adjacent light-shielding portions 101 is represented by the “length (Z) of the side β3” obtained by the above-described Equation (1). Accordingly, in the flat-convex lens 110, a plurality of the light-shielding portions 101 is formed corresponding to the light-shielding target regions of the unnecessary component output elements.

In this manner, the lens sheet 11 where the light-shielding portions 101 are formed functions as the optical device according to the present invention.

In the stereoscopic image display device 1 as the example of the first embodiment configured as described above, in a case where the stereoscopic image display is performed, first, an optical device configured to include the lens sheet 11 and the light-shielding portions 101 configured as described above is attached to the liquid crystal display 10, for example, as illustrated in FIG. 5. As described above, the lens sheet 11 is configured to include a plurality of the flat-convex lenses 110, each of which includes a plurality of the light-shielding portions 101 corresponding to the light-shielding target regions of the unnecessary component output elements.

As illustrated in FIG. 7, the generating line of each flat-convex lens 110 in the lens sheet 11 is arranged to be inclined along one diagonal line of the rectangular display element so as to be parallel to the alignment of each inclined row display element group on the display surface 10a of the liquid crystal display 10. In other words, the flat-convex lens 110 is arranged so as to overlap the diagonal line of the inclined row display element group. In addition, the width C of each of the flat-convex lenses 110 is formed corresponding to the horizontal length A of the display element on the display surface 10a of the liquid crystal display 10. For example, the width C of the flat-convex lens 110 is configured to satisfy, for example, C=A sin γ.

Accordingly, each inclined row display element group on the display surface 10a of the liquid crystal display 10 corresponds to any one of the flat-convex lenses 110. In addition, the alignment direction (the diagonal line passing through the display elements) of the display elements constituting the inclined row display element group and the direction of the generating line of the flat-convex lens 110 are coincident with each other.

In this state, the display control unit 12 displays the stereoscopic image on the liquid crystal display 10. More specifically, the display control unit 12 displays the stereoscopic image on the liquid crystal display 10 by controlling the luminance values and the like of the three display elements constituting the inclined row display element group on the display surface 10a of the liquid crystal display 10 corresponding to one pixel of stereoscopic image to be displayed.

In the lens sheet 11, the light output from the inclined row display element group is incident on the flat surface 110b of the flat-convex lens 110, which forms the output pair, and is irradiated from the convex lens 110a to be focused on the eyes of the viewer which is at a predetermined position.

However, in the lens sheet 11, the light output from the unnecessary component output elements which are not included in the output pair of the flat-convex lens 110 is prevented from entering the flat surface 110b by the light-shielding portions 101 for the flat-convex lens 110.

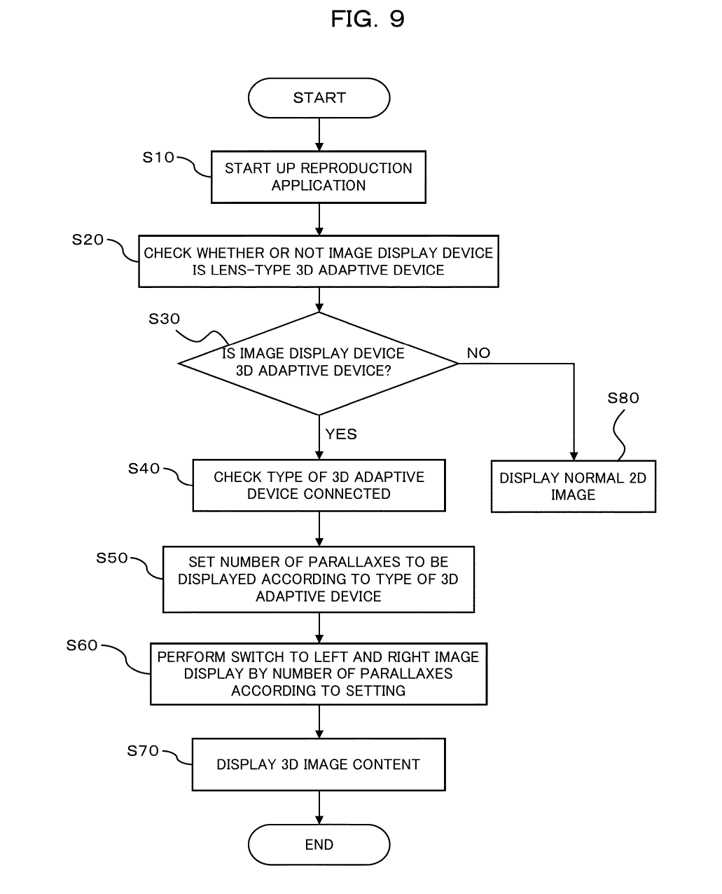

Next, processes of the display control unit 12 in the stereoscopic image display device 1 as the example of the first embodiment will be exemplarily described with reference to a flowchart (steps S10 to S80) illustrated in FIG. 9.

In the stereoscopic image display device 1, if the image reproduction application (reproduction application) is started up (step S10), the image reproduction application (the display control unit 12) first checks whether or not the stereoscopic image display device 1 is a lens-type stereoscopic image display device 1 (step S20). The checking is performed, for example, by checking a device ID or the like stored in the memory 136, the HDD 138, or the like of the display control unit 13 of the stereoscopic image display device 1.

Next, it is checked whether or not the lens sheet 11 (3D panel) is attached to the display unit 10 (step S30). For example, the display control unit 12 checks based on a result of sensing of a sensor which senses installation of the lens sheet 11 in the display unit 10 whether or not the lens sheet 11 is attached.

As a result of the checking, in a case where the lens sheet 11 is not attached to the display unit (refer to the route “No” in step S30), 2D display is performed (step S80). In other words, the same image is displayed as the left-eye image and the right-eye image on the display unit 10. In addition, at this time, a dialog box indicating that stereoscopic image display cannot be performed may be displayed on the display unit 10.

In addition, in a case where the lens sheet 11 is attached to the display unit 10 and 3D display can be performed (refer to the route “Yes” in step S30), the type of the 3D method is checked by checking a sheet ID of the attached lens sheet 11 (step S40). This is because the settings of the display pixel group is changed according to the number of parallaxes (the number of locations where 3D image is checked) which are to be displayed.

The display control unit 12 sets the number of parallaxes which are to be displayed according to the type of the checked 3D method (step S50) and switches to the left and right image displays at the number of parallaxes according to the settings (step S60).

Next, the display control unit 12 performs the 3D display by displaying the parallax image of the right eye and the parallax image of the left eye (3D image contents) by using the display elements (step S70). The process is ended.

In this manner, according to the stereoscopic image display device 1 as the example of the first embodiment, in the lens sheet 11, the light output from the unnecessary component output elements which are not included in the output pair of the flat-convex lens 110 is prevented from entering the flat surface 110b by the light-shielding portions 101 for the flat-convex lens 110. Accordingly, it is possible to prevent the occurrence of crosstalk.

### (B) Second Embodiment

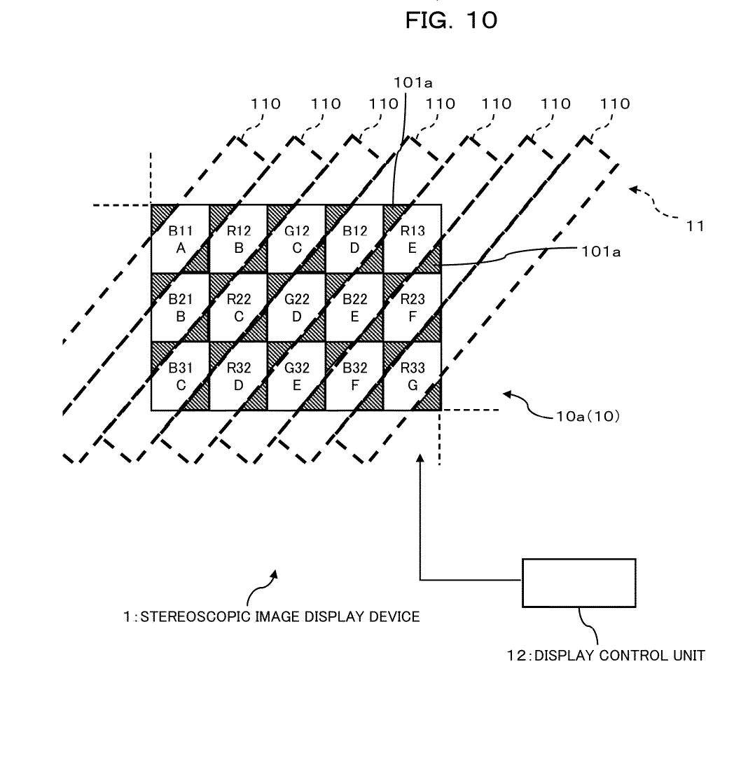

FIG. 10 is a schematic diagram illustrating a configuration of a stereoscopic image display device 1 as an example of a second embodiment.

As illustrated in FIG. 10, the stereoscopic image display device 1 as the example of the second embodiment is configured to include light-shielding portions 101a having the same shape as those of light-shielding target regions instead of the light-shielding portions 101 having a rectangular shape formed in the flat-convex lenses 110 according to the first embodiment, and other configurations of the stereoscopic image display device 1 according to the second embodiment are the same as those of the stereoscopic image display device 1 according to the first embodiment.

In other words, in the stereoscopic image display device 1 according to the second embodiment, the light-shielding portions 101a for the flat-convex lens 110 have the same shapes as those of the light-shielding target regions illustrated by the triangles T1 and T2 in FIGS. 7 and 8.

In this manner, according to the stereoscopic image display device 1 as the example of the second embodiment, it is possible to obtain the same functions and effects as those of the above-described first embodiment, and the light-shielding portions 101a do not prevent the light which is incident from the inclined row display element group, which forms the output pair together with the flat-convex lens 110, and input to the flat-convex lens 110 from entering. Accordingly, there is no decrease in luminance of the light output from each display elements of the inclined row display element group, which forms the output pair together with the flat-convex lens 110 constituting the output pair.

### (C) Others

The present invention is not limited to the above-described embodiments, but various modifications are available within the scope without departing from the spirit of the present invention.

For example, although the above-described embodiments exemplify the cases where the display unit 10 is a liquid crystal display, the display unit is not limited thereto, but display units such as a plasma display other than the liquid crystal display may be used, and appropriate modifications are available.

In addition, although the above-described embodiments exemplify the cases where the liquid crystal display 10 includes the display elements of the three types of color pixels R, G, and B, the display elements are not limited thereto, but display elements other than R, G, and B may be used.

In each of the above-described embodiments, although the light-shielding portions 101 (101a) are installed corresponding to the light-shielding target regions of the display surface 10a of the liquid crystal display 10, the light-shielding portions 101 (101a) do not necessarily cover the light-shielding target region. In other words, the light-shielding portions 101 (101a) may be arranged to cover at least a portion of the light-shielding target regions, and the light output from a portion of the light-shielding target regions may be prevented from being incident on the flat-convex lens 110. Accordingly, it is possible to obtain the effect that crosstalk can be reduced.

In addition, if the embodiments of the present invention are disclosed, the image display device and the optical device can be embodied and manufactured by the person skilled in the art.

According to the disclosed technique, it is possible to prevent the occurrence of crosstalk.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An image display device comprising:
a display unit where display elements are arranged in a matrix shape by arranging the display elements in an array direction and a direction perpendicular to the array direction;
a lens unit which is configured by arranging a plurality of lenses along an inclined row display element group including a plurality of display elements which are consecutively disposed in a direction inclined with respect to the array direction in the display unit, the lenses corresponding to the inclined row display element group, the lenses focusing output light of the display elements constituting the inclined row display element group; and
light-shielding portions which inhibit output light of unnecessary component output elements which are display elements other than the display elements constituting the inclined row display element group corresponding to the lenses from being emitted from the lenses.

2. The image display device according to claim 1, wherein the light-shielding portions are arranged between the display unit and the lenses to inhibit the output light of the unnecessary component output elements from being incident on the lens.

3. The image display device according to claim 1, wherein the light-shielding portions are formed corresponding to light-shielding target regions which are regions facing the lenses for the unnecessary component output elements.

4. The image display device according to claim 3, wherein the light-shielding portion is formed as a region including the light-shielding target region.

5. The image display device according to claim 3, wherein the light-shielding portion has the same shape as that of the light-shielding target region.

6. An optical device attached to a display unit where display elements are arranged in a matrix shape by arranging the display elements in an array direction and a direction perpendicular to the array direction, the optical device comprising:
a lens unit which is configured by arranging a plurality of lenses along an inclined row display element group including a plurality of display elements which are consecutively disposed in a direction inclined with respect to the array direction in the display unit, the lenses corresponding to the inclined row display element group, the lenses focusing output light of the display elements constituting the inclined row display element group; and
light-shielding portions which inhibit output light of unnecessary component output elements which are display elements other than the display elements constituting the inclined row display element group corresponding to the lenses from being emitted from the lenses.

7. The optical device according to claim 6, wherein the light-shielding portions are arranged between the display unit and the lenses to inhibit the output light of the unnecessary component output elements from being incident on the lens.

8. The optical device according to claim 6, wherein the light-shielding portions are formed corresponding to light-shielding target regions which are regions facing the lenses for the unnecessary component output elements.

9. The optical device according to claim 8, wherein the light-shielding portion is formed as a region including the light-shielding target region.

10. The optical device according to claim 8, wherein the light-shielding portion has the same shape as that of the light-shielding target region.
